(19) United States
(12) Patent Application Publication
(10) Pub. No.: US 2005/0116539 A1
(43) Pub. Date: Jun. 2, 2005

(54) Walking wheel for bicycle

(76) Inventor: Jiazheng Lu, Torrance, CA (US)

Correspondence Address: DAVID AND RAYMOND PATENT GROUP, 1050 OAKDALE LANE, ARCADIA, CA, 91006, US

(21) Appl. No.: 10/724,463

(22) Filed: Dec. 1, 2003

(51) Int. Cl. B62D 57/02; B60B 15/18

(52) U.S. Cl. 305/4

(57) ABSTRACT

A walking wheel for a bicycle riding on a ground surface comprises a hub, many supporting members outwardly extended from the hub, and many walking elements connected to the supporting members respectively. Each of the walking elements has a stepping surface defining a toe portion and a heel portion flexibly extended therefrom. The stepping surfaces of walking elements are coaxially aligned to the hub in a toe-to-heel manner to form a discrete driving surface in such a manner that when said hub is driven to rotate, one of the walking elements is arranged for stepping on the ground surface in a human toe-heel walking manner.

### BACKGROUND OF THE PRESENT INVENTION

1. Field of Invention

The present invention relates to a bicycle, and more particular to a walking wheel comprising a plurality of walking elements discretely arranged around a hub, wherein the walking elements are capable of rotating in a stepping-like manner.

2. Description of Related Arts

Bicycles are heavily relied on many people as means for transportation or exercising and entertaining equipment. A basic bicycle includes a bicycle frame, steering assembly, transmission assembly, brake assembly and two wheels. The bicycle frame is usually made in a diamond shape with a front fork and back fork for receiving a front and rear wheels, respectively. The steering assembly is usually a T-shaped handlebar extended from the front fork in a manner suitable for a rider to lay his/her hands on. The transmission assembly includes a front sprocket, rear sprocket, chain and a pair of paddles. The paddles are coaxially secured to the center of the front sprocket, which, through the chain, is connected to the rear sprocket that is coaxially affixed to the rear wheel. A rider may step on the paddles to rotate the front sprocket, and the rotation movement is transmitted through the chain to the rear sprocket to rotate the rear wheel and drive the bicycle moving forward. The brake assembly usually includes a pair of brake levers, brake cables and brake pads. The brake pads are secured adjacent to the front and rear wheels, respectively, and connected to the brake levers via the brake cables. A rider may squeeze the brake levers and the handlebars to pull the brake cable to press the brake pads against the wheels for braking.

Traditionally, a bicycle wheels is constituted of a hub, rim, inflatable tire and a plurality of spokes. The spokes radically extends from the hub to the inner side of the rim. The inflatable tire is disposed around the rim and a chamber is formed therebewteen, into which pressured air is pumped to keep the tire inflated. The bicycle wheel is disposed between the two branches of the fork and rotatably connected therebetween.

The inflated tire sustains the weight of the bicycle and provides a contact surface with the ground for generation of fiction. Because the contacting area between the tire and ground bears the weigh of the bicycle, the pressure in the contacting area is greater than any other areas of the tire. The pressure forms a contacting area between the tire and ground, where friction is thereby generated. As a rider steps on the paddles, the transmission assembly transforms the stepping movement into rotating movement for the wheel, wherein the contacting area works as a pivot point to pivotally move the hub forward via the spokes as the leverage. As the hub moves forward, the spokes in turn rotate the current contacting area departing from the ground and replace it with the adjacent surface of the tire. Although how the tire contacts with the ground may sound discrete, it actually works in a continuous way.

A drawback of the traditional bicycle tire is its inability of accommodating the difficult terrain, such as rough, rocky, sandy, muddy and bumpy roads. One reason for that is the rather limited contacting area between the tire and ground. When the tire is proper inflated, the weight of the bicycle plus average loading would deform the tire a little bit and generate a rather great pressure to the ground. Say, if a person rides the bicycle on a muddy road, the pressure between the tire and the round would make the wheel easily sink into the muddy road, and a lot of efforts of moving the bicycle forward would be wasted. The softness and liquidness of the muddy road provides insufficient reaction force to properly deform the tire for a contacting area with adequate fraction generated. A part of the energy spent for rotating the wheel would be wasted in deforming the muddy road under the tire instead of generation sufficient friction for the bicycle going forward.

One solution to the abovementioned drawback can by found in a United States patent Application Publication numbered as U.S. 2001/0007388. It discloses a bicycle designed for riding on all-terrain with unconventional wheels, each of which has a circular rim that is interconnected to a hub by spokes. A surface engaging support shoes assembly is attached on the rim to provide support of the bicycle on a surface, wherein each engaging support shoe of the assembly is discontinuous and capable of pivotal movement with respect to the rim so that the assembly keeps better contact with the ground than traditional tires when the bicycle is moving.

Some feature of the abovementioned bicycle limits its ability of accommodating very difficult terrain. First, only one pivotal joint is provided between the engaging support shoe and the rim. This prevents each engaging support shoe from further adjusting its contacting surface with the ground to optimize the contacting area for better generation of friction. Second, because the engaging support shoes assembly is pivotally attached around the rim, in order to avoid the rim contacting with the ground directly, the engaging support shoes must be arranged in a close manner. In other words, the wheel employing the engaging support shoes assembly rotates more like traditional wheels and therefore cannot overcome an obstacle by stepping on top of it like a human being does. Third, the wheel has no suspension mechanism on it, so that the shock would be transferred directly from the ground through the wheel to the bicycle frame.

How to absorb the shock from the ground to the wheel is an important issue to the technical field of wheels. Such shock-absorbing wheel, albeit not necessarily used in bicycles, may be found in a United States patent numbered as U.S. Pat. No. 4,420,192, wherein a wheel having two staggered rows of surface-gripping, radially-yielding feet. When the wheel encounters an obstacle, a spring compresses, thereby permitting the feet to deflect and absorb shock that would have otherwise been impacted to the vehicle.

The abovementioned wheel may have many “feet” members, but it does not function like the stepping movement a human being does, which is known as one of the most ingenious natural mechanism in terms of overcoming obstacles. The stepping movement requires a pivotal joint connecting the leg to the heel and another pivotal joint connecting the heel to the toe. When a person is walking, the heel lands on the ground first and the leg moves forward to place the body weight on the toe, and the heel leaves the ground by using the toe as a pivotal point to move the leg further forward. However, the abovementioned “foot” of the wheel does not have joints like a real foot of human being. The contact surface of the “foot” is a piece of solid rubber without any mechanism like the interaction of toe and heel of a human foot. Thus, it may not functions as good as a human foot in terms of overcoming obstacles.

### SUMMARY OF THE PRESENT INVENTION

A main objective of the present invention is to provide a walking wheel comprising a plurality of walking elements discretely and coaxially disposed around a hub to form a wheel-like discontinuous arrangement of walking surfaces that are capable of adjusting their contacting areas with the ground so that the gripping of the walking wheel with respect to the ground is therefore enhanced.

Another objective of the present invention is to provide a walking wheel comprising a plurality of walking elements discretely disposed around a hub via corresponding supporting members, wherein the walking element currently contacting with the ground provides friction for moving the hub forward to rotate the next walking element to step on the ground and lift the current walking element so that the walking wheel is capable of imitating stepping movement of human beings that is particularly suitable to ill-conditioned terrain over the conventional tires.

Another objective of the present invention is to provide a walking wheel comprising a walking element substantially constituted of a toe portion and heel potion capable of pivotal movement with respect to each other, wherein the heel portion is predominately in contact with the ground as the walking element is arriving the ground and the toe portion is predominately in contact with the ground as the walking element is departing the ground, so that the walking element is able to move on the ground in a stepping-like manner, which always keep the walking element in good contact with the ground in a balanced way.

Another objective of the present invention is to provide a walking wheel comprising a walking element with a suspension device to absorb impact generated when the walking element is arriving and departing the ground so as to keep the walking wheel moving stable on difficult terrain.

Another objective of the present invention is to provide a walking wheel comprising walking elements with aesthetic dressing for appearance of entertainment, fashion and uniqueness.

Another objective of the present invention is to provide a bicycle adopting the abovementioned walking wheels so as to enable the bicycle to move on difficult terrain and convey the appearance of entertainment, fashion and uniqueness.

One embodiment of the present invention discloses a walking wheel for a bicycle riding on a ground surface, comprising: a hub for rotatably mounting to said bicycle; a plurality of supporting members outwardly extended from said hub; a plurality of walking elements connected to said supporting members respectively, wherein each of said walking elements has a stepping surface defining a toe portion and a heel portion flexibly extended therefrom, wherein said stepping surfaces of said walking elements are coaxially aligned to said hub in a toe-to-heel manner to form a discrete driving surface in such a manner that when said hub is driven to rotate, one of said walking elements is arranged for stepping on said ground surface in a human toe-heel walking manner that said heel portion of said stepping surface of said following walking element steps on said ground surface when said heel portion of said stepping surface of said preceding walking element lifts up from said ground surface.

Another embodiment of the present invention discloses a bicycle for riding on a ground surface comprises: a bicycle frame for structural sustention; a steering assembly for steering said bicycle frame to a certain direction; two walking wheels comprising: a hub for rotatably mounting to said bicycle frame; a plurality of supporting members outwardly extended from said hub; a plurality of walking elements connected to said supporting members respectively, wherein each of said walking elements has a stepping surface defining a toe portion and a heel portion flexibly extended therefrom, wherein said stepping surfaces of said walking elements are coaxially aligned to said hub in a toe-to-heel manner to form a discrete driving surface; and a transmission system for receiving and transferring input energy to drive at least one of said walking wheels in such a manner that when said hub is driven to rotate, one of said walking elements is arranged for stepping on said ground surface in a human toe-heel walking manner that said heel portion of said stepping surface of said following walking element steps on said ground surface when said heel portion of said stepping surface of said preceding walking element lifts up from said ground surface.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a bicycle employing walking wheels according to one preferred embodiment of the invention.

FIG. 2 is a front view of the waking wheel according to the preferred embodiment of the invention.

FIG. 3 is a front view of the hub of waking wheel according to the preferred embodiment of the invention.

FIG. 4 is a top view of the hub of walking wheel according to the preferred embodiment of the invention.

FIG. 5 is a cross-sectional view of the walking element connected with the supporting member of the walking wheel according to the preferred embodiment of the invention.

### DETAILED DESCRIPTION OF THE PREFERRED EMBODIMENT

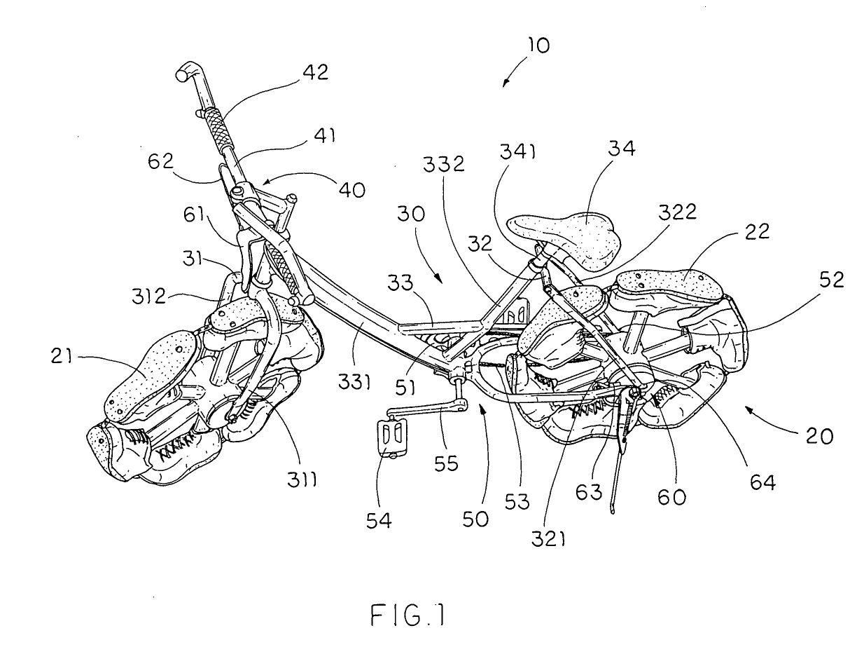

Referring to FIG. 1, a perspective view of a bicycle 10 that employs the walking wheels 20 according to a preferred embodiment of invention is illustrated. The bicycle 10 comprises a bicycle frame 30, steering assembly 40, transmission assembly 50, brake assembly 60 and walking wheels 20. A front walking wheel 21 is secured at a front portion of the bicycle frame 30 in a rotating manner and a back walking wheel 22 is secured at a rear portion of the bicycle frame 30 in a rotating manner. The steering assembly 40 is mechanically connected to the front walking wheel 21 for steering the bicycle 10. The transmission assembly 50 is mechanically connected to the rear walking wheel 22 for transmitting input kinetic energy to drive the rear walking wheel 22 for rotation. The brake assembly 60 is provided for stopping the movement of the bicycle.

The bicycle frame 30 comprises a front fork 31, rear fork 32, main frame 33 and seat 34. The main frame 33, which is made in a diamond shape, comprises a first elongated bar 331 and second elongated bar 332 connected with each other, substantially defining the operating space for a bicycle rider. The front fork 31, constituted of a first front branch 311 and second front branch 312, downwardly extends from a far end of first elongated bar 331 with respect to the seat 34. Likewise, the rear fork 32, constituted of a first rear branch 321 and second rear branch 322, downwardly extends from a top end of the second elongated bar 332.

The front walking wheel 21 is rotatably secured between the first front branch 311 and second front branch 312 along its axis, and the rear walking wheel 22 is rotatably secured between the first rear branch 321 and second rear branch 322 along its axis. The seat 34 is securely mounted on top of the second elongated bar 332 for sitting the rider thereon. In addition, the second elongated bar 332 is a hollow cylinder into which a seat bar 341 protruded from the seat 34 is inserted, so that the height of the seat 34 is adjustable by moving the seat bar 341 along within the second elongated bar 322 and secure them together for a desirable height for the seat 34. It is noted that another structure may be provided for the bicycle frame without departing the spirit of the invention.

The steering assembly comprises a T-shaped steering handlebar 41 and two handle surfaces 42 are provided on the two ends of the horizontal part of the T-shaped steering handlebar 41 for ease of gripping by the rider. The T-shaped steering handle bar 41 is fixedly connected to the front fork 31 in such a manner that the front fork 31 and front walking wheel 21 may be turned clockwise or counter-clockwise by virtue of maneuvering the handlebar 41. The handle surfaces 42 are two flexible tubes fitted at the two ends of the horizontal part of the T-shaped steering handlebar 41. A certain pattern is provided on the handle surfaces 42 for increasing the friction between the rider's hand and the handle surfaces 42.

The transmission assembly 50 comprises a front sprocket 51, rear sprocket 52, chain 53, a pair of paddles 54 and a pair of leverages 55. The front sprocket 51 is rotatably mounted at the junction of the first elongated bar 331 and second elongated bar 332. The pair of paddles 54 is connected to the front sprocket 51 via the leverages 55 in such as manner that the stepping movement of the paddles 54 can be transferred into rotating movement of the front sprocket 51. The front sprocket 51 is connected to the rear sprocket 52 via the chain 53, and the teeth of the front sprocket 51 drive the chain 53 to move in a loop manner that in turn drives the rear sprocket 52 to rotate by virtue of the engagement of teeth therebetween. The rear sprocket 52 is coaxially secured to the rear walking wheel 52, so that the rotation movement of the rear sprocket 52 drives the rear walking wheel 52 to rotate. It is noted that the front sprocket 51 and rear sprocket 52 may be made as sets of sprockets to provide various gears.

The brake assembly 60 comprises a hand brake lever 61, cable 62, brake pad 63 and disc 64. The brake lever 61 is connected to the brake pad 63 through the cable 62. The brake pad 63 is disposed adjacent to the surface of disc 64, which is coaxially secured to the rear walking wheel 52. A rider may squeeze the brake lever 61 with respect to the T-shaped steering handlebar 41 to pull up the cable 62 to press the brake pad 63 against the disc 64, and the friction between the brake pad 63 and disc 64 may gradually stop the rotation movement of the rear walking wheel 22 for braking. It is noted that the brake assembly 60 can be provided for both the front walking wheel 21 and rear walking wheel 22 for better braking effect.

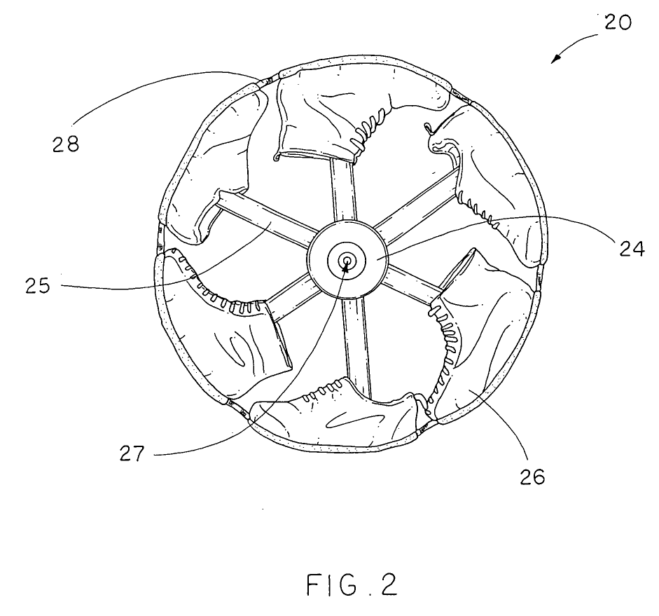

Referring to FIG. 1 and FIG. 2, a side view of the walking wheel 20 according to the preferred embodiment of the invention is illustrated. The walking wheel 20 comprises a hub 24, a plurality of supporting members 25 outwardly extended from the hub 24, and a plurality of walking elements 26. The hub 24 has an axial slot 27 passing through its center for receiving a bolt to rotatably mount the walking wheel 20 to the bicycle frame 30. When the transmission assembly 50 drives the rear walking wheel 22 to rotate, the contacting area between the walking element 26 and ground provides a friction as a pivot point for moving its corresponding supporting member 24 forward, such that the rotation movement of the walking wheel 22 is transferred into the linear movement of the bicycle 10.

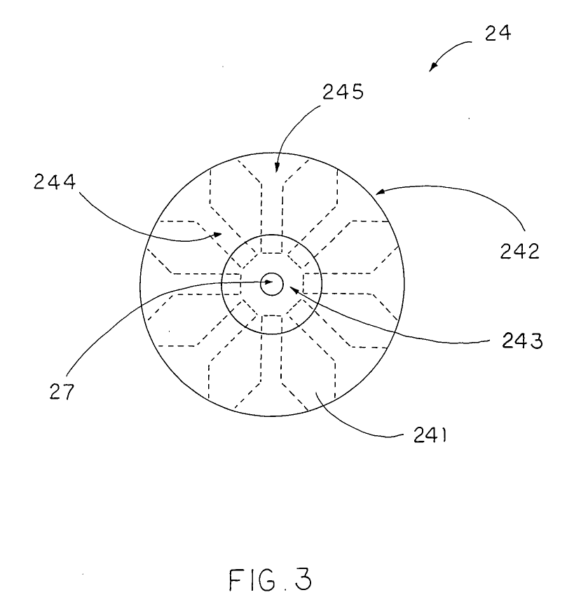

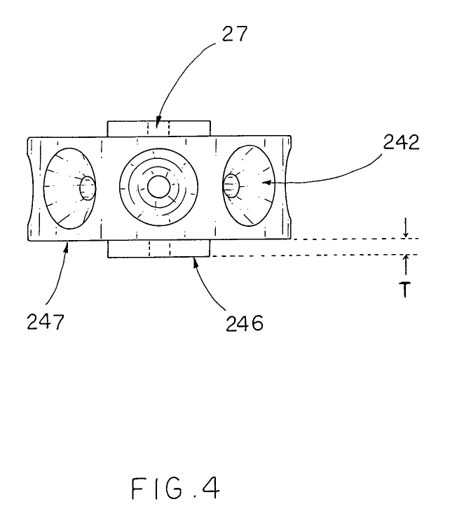

Referring to FIG. 3 and FIG. 4, the hub 24 comprises a body 241, in which a plurality of radial slots 242 is formed, and a protruded portion 243 is illustrated. The body 241 is made in a cylinder shape, around the outer circumferential surface of which a plurality of the radial slots 242 are spacedly provided for receiving the supporting members 25 (see FIG. 2). Each of the radial slots 242 has an elongated portion 244 that has a diameter slightly greater than that of the supporting member 25, and a funnel-like receiving portion 245 outwardly extending from the elongated portion 244 for ease of inserting the supporting member 25 into the elongated portion 244. The supporting member 25 is affixed within the radial slot 242 by means of wielding. It is noted that the supporting members 25 and hub 24 may be formed integrally, or connected by means, like bolt-and-nuts, screws, rivets and adhesive.

The front surface 246 of protruded portion 243 has a thickness T from the front surface 247 of body 241 for avoiding substantial interference between the front surface 247 and front fork 31 or rear fork 32, when the waking wheel 20 is rotatably secured therebetween. In this preferred embodiment, the protruded portion 243 is integrally formed on the front side of the body 241 of hub 24. It is noted that the protruded portion may be a foreign part coaxially attached to the axial slot 27 on the font surface 247 of body 241 by virtue of welding or adhesive.

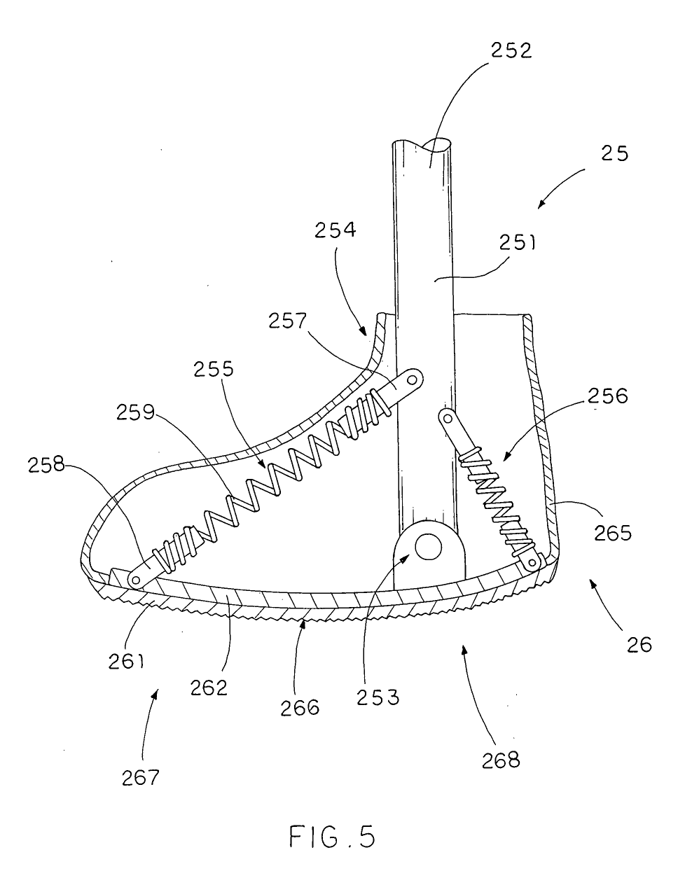

Referring to FIG. 2 and FIG. 5, a cross-sectional view of the walking element 26 connected with the supporting member 25 of walking wheel 20 according to the preferred embodiment of the invention is illustrated.

Each of the walking elements 26 has a stepping surface 266 with non-slipping treatment thereon to better gripping between the stepping surface 266 and the ground surface. The stepping surface 266 of the walking element 26 has a predetermined curvature to from an arc of the discrete driving surface of walking wheel 20. The stepping surfacing 266 defines a toe portion 267 and a heel portion 268 flexibly extended therefrom. The stepping surfaces 266 of the walking elements 26 are coaxially aligned to the hub 24 in a toe-to-heel manner to form a discrete driving surface with respect to the hub 24.

Therefore, when the hub 24 is driven to rotate, one of the walking elements 26 is arranged for stepping on the ground surface in a human toe-heel walking manner that the heel portion 268 of stepping surface 266 of the following walking element 26 steps on the ground surface when the heel portion 268 of stepping surface 266 of preceding walking element 26 lifts up from said ground surface.

Each of the supporting members 25 comprises an elongated supporting leg having an inner end 252 radially extended from the hub 24 and an outer end 253 pivotally connected to the respective walking element 26. The supporting member 25 further comprises an ankle joint 254 coupling the supporting leg 251 with the respective walking element 26.

Accordingly, the ankle joint 254 comprises two resilient elements, toe spring element 255 and heel spring element 256, coupling the supporting leg with the toe portion 267 and the heel portion 268 respectively for applying an urging pressure against walking element 26 to regularly maintain the stepping surface 266 in a curved-shape. Either toe spring element 255 or heel spring element 256 comprises a first extension rod 257, second extension 258 and spring 259. The first extension rod 257 is connected to the supporting leg 251 with its one end and to the spring 259 with another end. Likewise, the second extension rod 258 is connected to the walking frame 262 with its one end and the spring 255 with another end. The spring 259 is flexible along its longitudinal direction and rigid enough to resist deformation at its transverse direction.

Each of the walking elements 26 comprises a walking frame 262, having an arc-shape, pivotally connected to the respective supporting member 25, and a shoe 265 having a bottom non-slipping surface 261 as the stepping surface 266, wherein the shoe 265 is replaceably worn at the walking frame 262 to reinforce the curvature of the stepping surface 266 of the shoe 265, as shown in FIG. 5. In other words, the driver is able to replace his or her shoe 265 to form the walking wheel of the present invention while the arc-shaped walking frame 262 is adapted to reinforce the bottom surface 261 of the shoe 265 to be bent at the curvature of the stepping surface 266 of the walking element 26.

As shown in FIG. 2, the walking wheel further comprises a plurality of guiding elements 28 connecting the walking elements 26 respectively, wherein each of the guiding elements 28 has two ends respectively connecting the toe portion 267 of the preceding walking element 26 to the heel portion 268 of the following walking element 26 so as to alignedly guide the walking elements 26 in a toe-to-heel manner. Accordingly, each of the guiding elements 28 is embodied as a short metal chain. It is noted that the guiding element 28 could also be a rope or string to connect between each two walking elements 26.

How the walking element 26 works is explained as the following. When the walking element 26 is arriving the ground, the heel potion 268 lands the ground first. At this moment, a contacting area is formed between the heel portion 268 of walking element 26 and the ground. The friction between the heel portion 268 and the ground works as a pivot point for the hub 24 with the supporting member 25 as the leverage so as to move the hub 24 forward. As the hub 24 is moving forward, the weight of the walking wheel 20 and bicycle 10 shifts along with the forward movement, so as to push the toe portion 267 contacting with the ground. When the walking element 26 is departing the ground, the friction between the toe portion 267 and the ground provides as a pivot point for the hub 24 with the supporting member 25 as the leverage, so as to lift the heel potion 268 from the ground. At this point, resilient elements 255 and 256 absorb the shock from the ground. Then, the hub 24 keeps moving forward until the toe portion 267 departs from the ground, so as to complete a stepping movement for a walking element 26.

It is noted that there is only one circular row of walking elements are provided for a walking wheel, two or more rows of walking elements 26 that are arranged either staggeredly or alignedly can be employed without departing the spirit of the invention.

The disclosed walking element provides the following advantages. First, because the walking elements 26 discretely disposed around the hub 24 to form a wheel-like discontinuous arrangement of steeping surfaces 266 that are capable of adjusting their contacting areas with the ground for arriving and departing stages, the gripping of the walking wheel 20 with respect to the ground is therefore enhanced in response to the shift of the carried weight of the walking wheel. Second, the walking wheel 20 is capable of imitating stepping movement of human beings that is particularly suitable to ill-conditioned terrain over the conventional tires. Third, the walking element 26 is able to move on the ground in a stepping-like manner, which always keeps the walking element 26 in good contact with the ground in a balance way, especially when it is used in difficult terrain, like muddy or rocky road. Fourth, the resilient elements 255 and 256 are capable of absorbing impact generated when the walking element 20 is arriving and departing the ground so as to keep the walking wheel moving stable on difficult terrain. Fifth, the shoe replace 265 conveys the appearance of entertainment, fashion and uniqueness.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A walking wheel for a bicycle riding on a ground surface, comprising:
a hub adapted for rotatably mounting to said bicycle;
a plurality of supporting members outwardly extended from said hub;
a plurality of walking elements connected to said supporting members respectively, wherein each of said walking elements has a stepping surface defining a toe portion and a heel portion flexibly extended therefrom, wherein said stepping surfaces of said walking elements are coaxially aligned to said hub in a toe-to-heel manner to form a discrete driving surface with respect to said hub in such a manner that when said hub is driven to rotate, one of said walking elements is arranged for stepping on said ground surface in a human toe-heel walking manner that said heel portion of said stepping surface of said following walking element steps on said ground surface when said heel portion of said stepping surface of said preceding walking element lifts up from said ground surface.

2. The walking wheel, as recited in claim 1, wherein said stepping surface of each of said walking elements has a predetermined curvature to from an arc of said discrete driving surface of said walking wheel.

3. The walking wheel, as recited in claim 1, wherein each of said supporting members comprises an elongated supporting leg having an inner end radially extended from said hub and an outer end pivotally connected to said respective walking element.

4. The walking wheel, as recited in claim 2, wherein each of said supporting members comprises an elongated supporting leg having an inner end radially extended from said hub and an outer end pivotally connected to said respective walking element.

5. The walking wheel, as recited in claim 3, wherein each of said supporting members comprises an ankle joint coupling said supporting leg with said respective walking element, wherein said ankle joint comprises two resilient elements coupling said respective supporting leg with said toe portion and said heel portion respectively for applying an urging pressure against said walking element.

6. The walking wheel, as recited in claim 4, wherein each of said supporting members comprises an ankle joint coupling said supporting leg with said respective walking element, wherein said ankle joint comprises two resilient elements coupling said respective supporting leg with said toe portion and said heel portion respectively for applying an urging pressure against said walking element.

7. The walking wheel, as recited in claim 2, wherein each of said walking elements comprises a walking frame, having an arc-shape, pivotally connected to said respective supporting member, and a shoe having a bottom non-slipping surface as said stepping surface, wherein said shoe is replaceably worn at said walking frame to reinforce said curvature of said stepping surface of said shoe.

8. The walking wheel, as recited in claim 4, wherein each of said walking elements comprises a walking frame, having an arc-shape, pivotally connected to said respective supporting member, and a shoe having a bottom non-slipping surface as said stepping surface, wherein said shoe is replaceably worn at said walking frame to reinforce said curvature of said stepping surface of said shoe.

9. The walking wheel, as recited in claim 6, wherein each of said walking elements comprises a walking frame, having an arc-shape, pivotally connected to said respective supporting member, and a shoe having a bottom non-slipping surface as said stepping surface, wherein said shoe is replaceably worn at said walking frame to reinforce said curvature of said stepping surface of said shoe.

10. The walking wheel, as recited in claim 1, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.

11. The walking wheel, as recited in claim 4, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.

12. The walking wheel, as recited in claim 9, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.

13. A bicycle for riding on a ground surface, comprising:
a bicycle frame having a front portion and a rear portion;
a steering assembly for steering said bicycle frame to a certain direction;
two walking wheels rotatably mounted at said front and rear portion, wherein each of said walking wheels comprises:
a hub for rotatably mounting to said bicycle frame;
a plurality of supporting members outwardly extended from said hub; and
a plurality of walking elements connected to said supporting members respectively, wherein each of said walking elements has a stepping surface defining a toe portion and a heel portion flexibly extended therefrom, wherein said stepping surfaces of said walking elements are coaxially aligned to said hub in a toe-to-heel manner to form a discrete driving surface; and
a transmission means for driving at least one of said walking wheels to rotate, wherein when said hub is driven to rotate, one of said walking elements is arranged for stepping on said ground surface in a human toe-heel walking manner that said heel portion of said stepping surface of said following walking element steps on said ground surface when said heel portion of said stepping surface of said preceding walking element lifts up from said ground surface.

14. The walking wheel, as recited in claim 10, wherein said stepping surface of each of said walking elements has a predetermined curvature to from an arc of said discrete driving surface of said walking wheel.

15. The walking wheel, as recited in claim 14, wherein each of said supporting members comprises an elongated supporting leg having an inner end radially extended from said hub and an outer end pivotally connected to said respective walking element, and an ankle joint coupling said supporting leg with said respective walking element, wherein said ankle joint comprises two resilient elements coupling said respective supporting leg with said toe portion and said heel portion respectively for applying an urging pressure against said walking element.

16. The walking wheel, as recited in claim 14, wherein each of said walking elements comprises a walking frame, having an arc-shape, pivotally connected to said respective supporting member, and a shoe having a bottom non-slipping surface as said stepping surface, wherein said shoe is replaceably worn at said walking frame to reinforce said curvature of said stepping surface of said shoe.

17. The walking wheel, as recited in claim 15, wherein each of said walking elements comprises a walking frame, having an arc-shape, pivotally connected to said respective supporting member, and a shoe having a bottom non-slipping surface as said stepping surface, wherein said shoe is replaceably worn at said walking frame to reinforce said curvature of said stepping surface of said shoe.

18. The walking wheel, as recited in claim 13, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.

19. The walking wheel, as recited in claim 15, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.

20. The walking wheel, as recited in claim 17, further comprising a plurality of guiding elements connecting said walking elements respectively, wherein each of said guiding elements has two ends respectively connecting said toe portion of said preceding walking element to said heel portion of said following walking element so as to alignedly guide said walking elements in a toe-to-heel manner.
